(19) United States
(12) Patent Application Publication
(10) Pub. No.: US 2021/0219045 A1
(43) Pub. Date: Jul. 15, 2021

(54) Bass Augmentation Speaker System

(71) Applicant: Robert John Schunck, St. Petersburg, FL (US)

(72) Inventor: Robert John Schunck, St. Petersburg, FL (US)

(21) Appl. No.: 17/148,193

(22) Filed: Jan. 13, 2021

Related U.S. Application Data
(60) Provisional application No. 62/960,462, filed on Jan. 13, 2020.

(51) Int. Cl. H04R 1/28; H04R 1/02

(52) U.S. Cl. CPC H04R 1/2819; H04R 1/02

(57) ABSTRACT

Disclosed is a speaker that includes an outer housing and a series of diametrically opposed drivers. A central divider is included within the interior of the housing. Apertures are included within the central divider for equalizing the pressure within the housing.

### CROSS REFERENCE TO RELATED APPLICATIONS

This application claims priority to, and is a continuation of, U.S. Provisional Patent Application Ser. No. 62/960,462 filed on Jan. 13, 2020 and entitled “Bass Augmentation Speaker System.” The contents of this co-pending application are fully incorporated herein for all purposes.

### BACKGROUND OF THE INVENTION

### Field of the Invention

The present invention relates to a bass augmentation speaker system for low frequency audio reproduction.

### Description of the Prior Art

The use of subwoofer systems of known designs and configurations is known in the prior art. More specifically, subwoofer systems of known designs and configurations previously devised and utilized for the purpose of low frequency audio reproduction are known to consist basically of familiar, expected, and obvious structural configurations, notwithstanding the myriad of designs encompassed by the crowded prior art which has been developed for the fulfillment of countless objectives and requirements.

While these devices fulfill their respective, particular objectives and requirements, they do not describe a bass augmentation speaker system for low frequency audio reproduction.

In this respect, the bass augmentation speaker system according to the present invention substantially departs from the conventional concepts and designs of the prior art, and in doing so provides an apparatus primarily developed for the purpose of low frequency audio reproduction.

Therefore, it can be appreciated that there exists a continuing need for a new and improved bass augmentation speaker system which can be used for low frequency audio reproduction. In this regard, the present invention substantially fulfills this need.

### SUMMARY OF THE INVENTION

In view of the disadvantages inherent in the known types of subwoofer systems of known designs and configurations now present in the prior art, the present invention provides an improved bass augmentation speaker system. As such, the general purpose of the present invention, which will be described subsequently in greater detail, is to provide a new and improved bass augmentation speaker system and method which has all the advantages of the prior art and none of the disadvantages.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the invention be regarded as including such equivalent constructions insofar as they do not depart from the spirit and scope of the present invention.

For a better understanding of the invention, its operating advantages and the specific objects attained by its uses, reference should be had to the accompanying drawings and descriptive matter in which there is illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a front elevational view of a subwoofer system for low frequency audio reproduction constructed in accordance with the principles of the present invention.

FIG. 2 is a plan view taken along line 2-2 of FIG. 1.

FIG. 3 is a left side elevational view taken along line 3-3 of FIG. 1.

FIG. 4 is a right side elevational view taken along line 4-4 of FIG. 1.

FIG. 5 is a cross sectional view taken along line 5-5 of FIG. 1.

FIG. 6 is a cross sectional view taken along line 6-6 of FIG. 2.

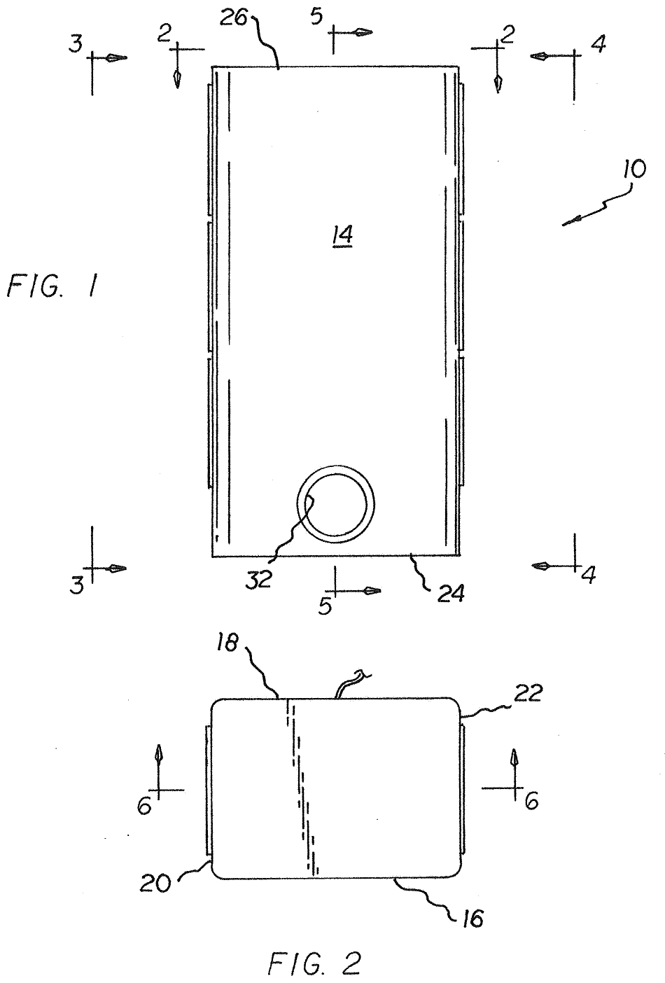

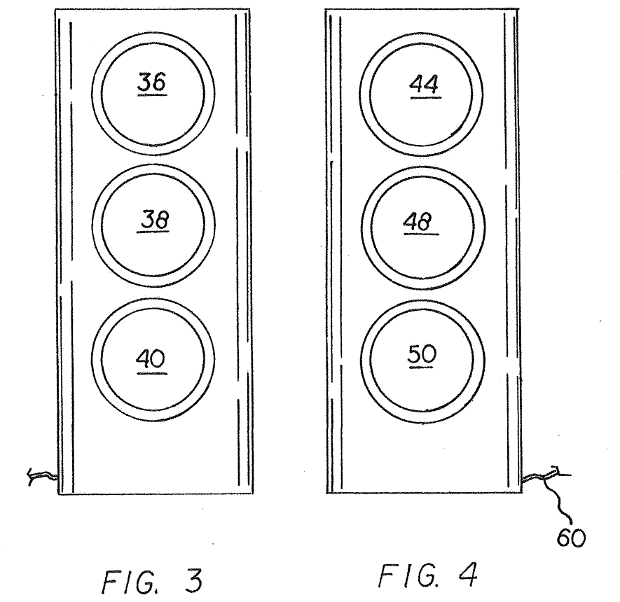

The same reference numerals refer to the same parts throughout the various Figures.

### DESCRIPTION OF THE PREFERRED EMBODIMENT

With reference now to the drawings, and in particular to FIG. 1 thereof, the preferred embodiment of the new and improved bass augmentation speaker system embodying the principles and concepts of the present invention and generally designated by the reference numeral 10 will be described.

The present invention, the bass augmentation speaker system 10 is comprised of a plurality of components. Such components are individually configured and correlated with respect to each other so as to attain the desired objective. In their broadest context such include a housing, an air vent hole, a plurality of left drivers, and a plurality of right drivers.

From a broad viewpoint, first provided is a housing having front and rear faces, left and right sides, and a bottom and a top. A chamber is formed within the housing. An air vent hole is formed in the housing. A plurality of left drivers are mounted to the left side spaced and aligned with parallel axes. A plurality of right drivers are mounted in the right side spaced and aligned with parallel axes. The left driver are equal in number and size to the right drivers. Each left driver is axially aligned with an associated right driver.

In the preferred embodiment of the subwoofer system 10 for low frequency audio reproduction, first provided is a housing 14 formed in a rectilinear configuration. The housing has a front face 16 and a parallel rear face 18, a left side face 20 and a parallel right side face 22, and a bottom face 24 and a parallel top face 26. A chamber 28 is formed within the housing.

Next provided is an air vent hole 32. The air vent hole is formed in the front face adjacent to the bottom face.

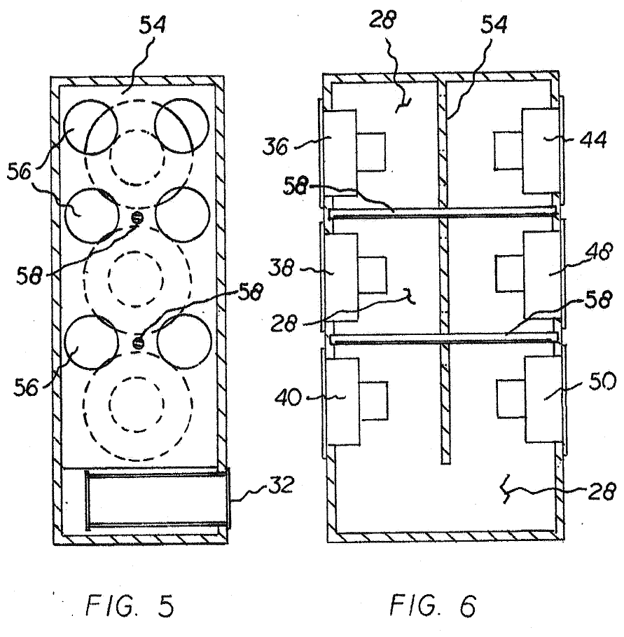

A plurality of left drivers 36, 38, 40 are next provided. The left drivers are mounted in the left face. The left drivers are elevationally spaced and vertically aligned with parallel axes. A plurality of right drivers 44, 48, 50 are provided next. The right drivers are mounted in the right face. The right drivers are elevationally spaced and vertically aligned with parallel axes. The left drivers (36, 38, 40) are positioned directly opposite to and in axial alignment with right drivers (44, 48, 50). Thus, any mechanical vibrations the drivers apply to housing 14 are opposed to one another. This means that any forces applied to housing 14 are equalized. The vibration canceling design creates an inert structure for the driver waveform to be launched from, which translates into a more accurate acoustic response. The opposed left and right drivers also generate back waves within the interior or chamber 28 of housing 14. These back waves take the form of acoustical waves. If unchecked, these waves would interfere with and crash into each other due to the opposed nature of the left and right drivers. Thus, central panel 54 is included to prevent these back waves from directly impacting one another. Apertures 56 are nonetheless included within central panel 54 to allow for the pressure to be equalized between opposing drivers. Notably, and as depicted in FIG. 5, these apertures 56 are not aligned with the axis of the opposing drivers. Instead, apertures 56 are spaced at a location about the periphery of the associated driver.

The left drivers are equal in number and size to the right drivers. Each left driver is axially aligned with an associated right driver.

Next a central panel 54 is provided. The central panel depends from the top face. The central panel is located between the left drivers and the right drivers. The central panel is parallel with the left side face and the right side face. A plurality of circular apertures 56 extend through the central panel. Each circular aperture has a central axis offset from the axes of the left drivers and the right drivers. Support rods 58 extend through the central panel with support rod ends coupled to the side faces.

Lastly, electrical leads 60 are provided. The electrical leads are operatively coupled to the drivers and are adapted to provide signals to activate the drivers.

The audio spectrum that human beings can hear consists of frequencies from 20 to 20,000 Hertz (Hz), or cycles per second. Doubling, or halving a frequency, equals one octave. There are approximately ten octaves in this audio spectrum. Subwoofers usually cover the lowest two octaves of 20 HZ to 80 HZ. The main satellite speakers cover the remaining eight octaves. The objective of a subwoofer/satellite system is to acoustically blend together seamlessly creating the acoustic response of a very large full range system. Subwoofers are also incorporated into home theater systems to realistically reproduce the power of explosions and other visceral low frequency sound effects.

Physics dictates that to reproduce low frequencies with power and authority, a subwoofer driver must move, push and pull, a lot of air. Because a driver's linear travel is limited by configuration constraints, a large diameter is the logical solution. Because of a large driver's moving mass, the response is usually “slower” than that of the associated, much smaller driver, satellite system. This translates into compromising the transient response of the system as it cannot track the incoming signal as faithfully as the smaller satellite system can. Therefore, a seamless acoustic result is usually unattainable. This is the main reason for the configuration of the present multi-driver 6, MD6, Bass Augmentation Speaker System. There are additional benefits of this configuration as well.

The MD6 preferably utilizes six 6.5 inch drivers. These drivers are configured for low frequency audio reproduction. These six drivers combine acoustically to move as much air as a 16 inch, 15.92 inch, driver while maintaining the reaction time of a 6.5 inch driver. These drivers are mounted in an opposing configuration, three on each side of the housing. They are wired in phase which creates a vibration canceling effect. This also allows for a vertically configured housing taking up less floor space than a typical large cube shaped subwoofer housing. This vibration canceling configuration also contributes to the system's transient behavior because the housing cannot “give way” to the forces exerted on it.

Realistic low frequency audio reproduction requires large amounts of amplifier power. Typical subwoofer configuration must consider this in the configuration of the driver incorporated. Heavy duty voice coil assemblies add to a driver's moving mass. The MD6's six drivers split the driving amplifier's power, allowing for effortless, low distortion performance.

Due to “Hoffman's Iron Law” (Josef Anton Hoffman), modern subwoofer configurations usually incorporate extreme electronic manipulation, especially low frequency boost. This enables these systems to provide impressive measured results using low level signals. However, as the output demands increase, the system must respond with frequency limiting, as well as compression (volume limiting) to maintain safe operating parameters. These are audible effects.

The MD6 operates strictly in the acoustic domain. Utilizing a modified EBS-3 vented alignment provides an acoustic in room response down to 25 HZ. This is also described as a critically damped alignment, contributing to the system's already impressive transient response. The modification incorporated ensures a smoother low frequency response in “real world” in room response. Room gain has been taken into account.

It is believed that the MD6 is unique in subwoofer configuration. So much so that we do not refer to it as a subwoofer. It is described as a Bass Augmentation Speaker System B. A. S. S.

As to the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed is:

1. A speaker for bass augmentation comprising:
an outer housing including first and second opposing sides and upper and lower end, the outer housing including an interior chamber;
a first series of three drivers positioned within the first opposing side, the first series of drivers being vertically arranged, each driver having a diameter of less than 8 inches;
a second series of three drivers positioned within the second opposing side, the second series of drivers being vertically arranged, each driver having a diameter of less than 8 inches, the first series of drivers being axially aligned within the second series of drivers, whereby any mechanical forces generated by the drivers upon the outer housing are equalized;
a central divider positioned within the interior chamber extending downwardly from the upper end but not contacting the lower end, a series of pressure equalizing holes positioned within the central divider, the equalizing holes not being axially aligned with the first and second series of drivers.

2. A speaker for bass augmentation comprising:
an outer housing including first and second opposing sides and upper and lower extents, the outer housing including an interior chamber;
a first series of drivers positioned within the first opposing side, the first series of drivers being vertically arranged;
a second series of drivers positioned within the second opposing side, the second series of drivers being vertically arranged;
wherein the first series of drivers are aligned within the second series of drivers along horizontal axes.

3. The speaker as described in claim 2 wherein a central divider is positioned within the interior chamber.

4. The speaker as described in claim 3 wherein the central divider extends downwardly from the upper extent but does not contact the lower extent of the housing.

5. The speaker as described in claim 3 wherein a series of pressure equalizing holes is positioned within the central divider.

6. The speaker as described in claim 5 wherein the equalizing holes being spaced from the horizontal axes of the first and second series of drivers.

7. The speaker as described in claim 6 wherein the equalizing holes are spaces about the periphery of the opposing first and second series of drivers.

8. The speaker as described in claim 2 wherein each of the drivers has a diameter of approximately 6.5 inches and is driving at 200 Hz or less.
